(19) United States
(12) Patent Application Publication
(10) Pub. No.: US 2026/0269625 A1
(43) Pub. Date: Sep. 10, 2026

(54) ELECTRONIC DEVICE AND METHOD FOR PREDICTING AMOUNT OF SOLAR POWER GENERATION

(71) Applicant: ENLIGHTEN CO., LTD., Seoul (KR)

(72) Inventors: Jae Min PARK, Seoul (KR); Dong-Woo LEE, Seoul (KR); Kun JOE, Seoul (KR); Hyo-Seon YOON, Seoul (KR)

(21) Appl. No.: 19/663,503

(22) Filed: Apr. 30, 2026

Related U.S. Application Data
(63) Continuation-in-part of application No. PCT/KR2024/014207, filed on Sep. 20, 2024.

(30) Foreign Application Priority Data
Oct. 30, 2023 (KR) 10-2023-0146758
Feb. 8, 2024 (KR) 10-2024-0019560

(51) Int. Cl. H02J 3/38; G05B 13/02; H02J 3/32; H02J 101/24; H02S 50/00

(52) U.S. Cl. CPC H02J 3/38; G05B 13/027; H02J 3/32; H02S 50/00; H02J 2101/24

(57) ABSTRACT

An electronic device includes a memory, and a processor operatively connected to the memory. The processor is configured to receive a plurality of weather forecast data, obtain a plurality of feature data based on the plurality of weather forecast data, obtain integrated feature data integrating the plurality of feature data based on a similarity among the plurality of feature data, and generate a predicted value of an amount of solar power generation based on the integrated feature data.

### CROSS-REFERENCE TO RELATED APPLICATION

The present application is a continuation in part of International Patent Application No. PCT/KR2024/014207, filed on Sep. 20, 2024, which claims priority to and the benefit of Korean Patent Application No. 10-2023-0146758, filed on Oct. 30, 2023, and Korean Patent Application No. 10-2024-0019560, filed on Feb. 8, 2024, in the Korean Intellectual Property Office, the entire disclosures of which are incorporated herein by reference.

### TECHNICAL FIELD

One or more embodiments relate to an electronic device and a method for predicting amount of solar power generation.

### BACKGROUND

As the demand for new and renewable energy increases, interest in solar power generation is also increasing. Solar power generation, which is a new and renewable energy, is expected to play a very important role in achieving the greenhouse gas reduction goal along with climate change in the 4th industrial revolution. Accordingly, the lifespan and efficiency of solar panels are being improved due to continuous support policies and technological advancements for the solar power generation industry, and facilities related to solar power generation are also being advanced.

Meanwhile, as the demand for new and renewable energy such as solar power generation increases, the importance of energy management is being highlighted. Energy management focuses on matching supply and demand, and because new and renewable energy converts the power of nature into energy, unlike thermal energy in which the supply amount may be freely controlled, prediction of the supply amount is necessary.

Recently, many studies have proposed methods of predicting an amount of solar power generation by utilizing an artificial neural network, but due to the uncertainty and variability of weather forecasts, prediction accuracy and consistency of performance are insufficient. For example, in a conventional method of predicting an amount of solar power generation, a prediction model is trained by utilizing weather observation data, and the amount of solar power generation may be predicted by using only one type of weather forecast data. However, in such a case, the weather forecast data used as an input value of the prediction model is limited, and in particular, when only single weather forecast data is used, usable information is limited, so there may be limitations in predicting the amount of solar power generation. Furthermore, the performance of the prediction model becomes highly dependent on the accuracy of the weather forecast data, so that when the weather forecast data has a large difference from the actual weather observation data, there is a high possibility that the prediction model outputs an amount of power generation that is very different from an actual amount of power generation. Accordingly, it is desirable to develop a technique capable of improving the accuracy and stability of solar power generation amount prediction.

### SUMMARY

The present disclosure may be implemented in various ways, including as a method, an apparatus (system), and/or a non-transitory computer-readable recording medium having instructions recorded thereon.

In some embodiments, an electronic device may include a memory, and a processor operatively connected to the memory. The processor is configured to receive a plurality of weather forecast data, obtain a plurality of feature data based on the plurality of weather forecast data, obtain integrated feature data integrating the plurality of feature data based on a similarity among the plurality of feature data, and generate a predicted value of an amount of solar power generation based on the integrated feature data. The electronic device may be coupled to or may communicate with at least one apparatus (e.g., an inverter, a power controller, a power storage, a power transfer apparatus, a power converter, etc.) coupled to at least one solar power generator associated with the solar power generation. The system leverages predictive analytics to optimize power distribution, load balancing, and energy storage across a network of interconnected devices and each group of one or more solar power generators.

In an example, the solar power generators comprise one or more photovoltaic (PV) panel arrays, each configured to convert incident solar irradiance into electrical energy. Each solar power generator may include one or more of the following components. A plurality of photovoltaic panels may be arranged in series and/or parallel configurations to achieve desired voltage and current output characteristics. Each example photovoltaic panel may comprise monocrystalline, polycrystalline, or thin-film photovoltaic cells, or any combination thereof. Each solar power generator may be operatively coupled to at least one MPPT controller configured to continuously optimize the electrical operating point of the photovoltaic panel array, thereby maximizing power extraction under varying environmental conditions including, but not limited to, solar irradiance levels, ambient temperature, and partial shading conditions. Each solar power generator may comprise at least one inverter operatively coupled to the photovoltaic panel array and configured to convert direct current (DC) electrical power generated by the photovoltaic panels into alternating current (AC) electrical power suitable for consumption by coupled devices or injection into an electrical grid. Each solar power generator may be operatively associated with one or more environmental sensors configured to measure parameters including, but not limited to, solar irradiance, ambient temperature, panel surface temperature, wind speed, and atmospheric humidity. The environmental sensor data may be communicated to the system to facilitate power generation prediction.

In an example, a plurality of devices may be operatively coupled to the solar power generators. The coupled devices may include, but are not limited to, the following. One or more energy storage devices, such as battery storage systems, may be operatively coupled to the solar power generators. The energy storage devices may comprise lithium-ion, solid-state, flow battery, or other electrochemical storage technologies configured to store excess electrical energy generated by the solar power generators and discharge stored energy during periods of insufficient solar power generation. The energy storage devices may comprise a battery management system (BMS) configured to monitor state of charge (SOC), state of health (SOH), and charge/discharge cycles. One or more load management devices may be operatively coupled to the solar power generators and configured to selectively connect or disconnect electrical loads based on predicted power generation levels received from the computing system. The load management devices may comprise smart circuit breakers, programmable load controllers, or demand response management systems configured to prioritize critical loads during periods of reduced solar power generation. One or more grid interface devices may be operatively coupled to the solar power generators and configured to facilitate bidirectional exchange of electrical power between the solar power generation system and an external electrical grid. The grid interface devices may comprise bidirectional inverters, grid synchronization controllers, and protective relay systems configured to ensure safe and compliant grid interconnection in accordance with applicable electrical standards. One or more DC-DC power converters may be operatively coupled to the solar power generators and configured to regulate and convert the voltage and current output of the solar power generators to levels compatible with the operational requirements of the coupled devices. The power conversion devices may further comprise galvanic isolation circuits to ensure electrical safety and prevent ground loop interference. One or more power monitoring and metering devices may be operatively coupled to the solar power generators and configured to continuously measure and record electrical parameters including, but not limited to, voltage, current, power factor, frequency, and cumulative energy production. The monitoring and metering devices may be configured to communicate measured data to the computing system via a wired or wireless communication interface. One or more communication interface devices may be operatively coupled to the solar power generators and configured to facilitate data exchange between the solar power generators, the coupled devices, and the computing system. The communication interface devices may support one or more communication protocols including, but not limited to, Modbus, CAN bus, Zigbee, Wi-Fi, cellular, or fiber optic communication interfaces. The system may be configured to receive and process input data from a plurality of sources, including: real-time and historical environmental sensor data from each solar power generator; meteorological forecast data obtained from external weather services; historical power generation data specific to each solar power generator; geographic and orientation data associated with each solar power generator; and/or real-time operational data from the coupled devices.

In some embodiments, the plurality of weather forecast data may include first weather forecast data including a weather predicted value of a first time interval within a designated time range, and second weather forecast data including a weather predicted value of a second time interval longer than the first time interval within the designated time range.

In some embodiments, the processor is configured to obtain a plurality of embedding vectors corresponding to the plurality of weather forecast data, respectively, as the plurality of feature data, and each embedding vector includes time-series information of corresponding weather forecast data among the plurality of weather forecast data, and has a designated length.

In some embodiments, the processor is configured to generate the plurality of embedding vectors using an attention-based Long Short-Term Memory (LSTM).

In some embodiments, the processor is configured to generate, for each of the plurality of feature data, a Query matrix, a Key matrix, and a Value matrix which are used for an attention model, based on the plurality of embedding vectors corresponding to the plurality of weather forecast data, respectively.

In some embodiments, the processor is configured to calculate a first attention score indicating a similarity between a corresponding query and a corresponding key based on a key matrix associated with first feature data among the plurality of feature data and a query matrix associated with second feature data among the plurality of feature data, calculate a first attention value based on the first attention score and a value matrix associated with the first feature data, calculate a second attention score indicating a similarity between corresponding a query and a corresponding key based on a key matrix associated with the second feature data and a query matrix of the first feature data, calculate a second attention value based on the second attention score and a value matrix associated with the second feature data, and generate the integrated feature data by concatenating the first attention value and the second attention value.

In some embodiments, the processor is configured to apply the integrated feature data to a Transformer model.

In some embodiments, the processor is configured to generate the predicted value of the amount of solar power generation through a Multi-Layer Perceptron model using the integrated feature data.

In some embodiments, an activation function of the Multi-Layer Perceptron may include a leaky Rectified Linear Unit (ReLU) function.

In some embodiments, a method of predicting an amount of solar power generation may be performed by at least one processor. The method may include receiving a plurality of weather forecast data, obtaining a plurality of feature data based on the plurality of weather forecast data, obtaining integrated feature data integrating the plurality of feature data based on a similarity among the plurality of feature data, and generating a predicted value of the amount of solar power generation based on the integrated feature data.

### BRIEF DESCRIPTION OF THE DRAWINGS

Embodiments of the present disclosure will be described with reference to the accompanying drawings described below, wherein like reference numerals denote like elements, but are not limited thereto.

FIG. 1 illustrates a configuration of an electronic device for predicting an amount of solar power generation according to an embodiment of the present disclosure.

FIG. 2 is a schematic diagram illustrating a configuration in which an information processing system is communicably connected to a plurality of user terminals, in relation to data processing according to an embodiment of the present disclosure.

FIG. 3 is a block diagram illustrating an internal configuration of a user terminal and an information processing system according to an embodiment of the present disclosure.

FIG. 4 illustrates a method of calculating a predicted value of an amount of solar power generation according to an embodiment of the present disclosure.

FIG. 5 illustrates a method of calculating an attention value according to an embodiment of the present disclosure.

FIG. 6 illustrates an artificial neural network model according to an embodiment of the present disclosure.

FIG. 7 illustrates a method of predicting an amount of solar power generation according to an embodiment of the present disclosure.

### DETAILED DESCRIPTION

Hereinafter, specific details for the implementation of the present disclosure will be described in detail with reference to the accompanying drawings. However, in the following description, if there is a concern that the gist of the present disclosure may be unnecessarily obscured, detailed descriptions of well-known functions or configurations will be omitted.

In the accompanying drawings, identical or corresponding components are given the same reference numerals. Furthermore, in the description of the following embodiments, redundant description of identical or corresponding components may be omitted. However, even if a description of a component is omitted, such a component is not intended to be excluded from any embodiment.

Advantages and features of the disclosed embodiments, and methods of achieving them, will become apparent with reference to the embodiments described below together with the accompanying drawings. However, the present disclosure is not limited to the embodiments disclosed below, but may be implemented in various different forms, and the present embodiments are provided only to make the present disclosure complete and to fully inform those skilled in the art of the scope of the invention.

Terms used in the present specification will be briefly described, and the disclosed embodiments will be described in detail. The terms used in the present specification have been selected from general terms that are currently widely used as much as possible while considering functions in the present disclosure, but the terms may vary depending on the intention of a technician working in the related field, precedents, or the emergence of new technology. Furthermore, in specific cases, there are terms arbitrarily selected by the applicant, and in such cases, the meaning thereof will be described in detail in the description part of the corresponding invention. Accordingly, the terms used in the present disclosure should be defined based on the meaning of the terms and the overall content of the present disclosure, not on the mere names of the terms.

In the present specification, expressions in the singular include expressions in the plural unless the context clearly specifies otherwise. Furthermore, expressions in the plural include expressions in the singular unless the context clearly specifies otherwise. When it is said throughout the specification that a certain part includes a certain component, the certain part does not exclude other components, but may further include other components, unless otherwise specifically stated.

Furthermore, the term “module” or “unit” used in the specification refers to a software or hardware component, and the “module” or “unit” performs certain roles. However, the “module” or “unit” is not meant to be limited to software or hardware. The “module” or “unit” may be configured to reside in an addressable storage medium, or may be configured to play one or more processors. Accordingly, as an example, the “module” or “unit” may include components such as software components, object-oriented software components, class components, and task components, as well as at least one of processes, functions, attributes, procedures, subroutines, segments of program code, drivers, firmware, microcode, circuitry, data, databases, data structures, tables, arrays, or variables. Functions provided within components and “modules” or “units” may be combined into a smaller number of components and “modules” or “units,” or may be further separated into additional components and “modules” or “units.”

According to an embodiment of the present disclosure, a “module” or “unit” may be implemented with a processor and a memory. The term “processor” should be broadly interpreted to include a general-purpose processor, a central processing unit (CPU), a microprocessor, a digital signal processor (DSP), a controller, a microcontroller, a state machine, and the like. In some environments, the term “processor” may refer to an application-specific integrated circuit (ASIC), a programmable logic device (PLD), a field programmable gate array (FPGA), and the like. The term “processor” may also refer to a combination of processing devices, such as, for example, a combination of a DSP and a microprocessor, a combination of a plurality of microprocessors, a combination of one or more microprocessors combined with a DSP core, or a combination of any other such configuration. Furthermore, the term “memory” should be broadly interpreted to include any electronic component capable of storing electronic information. The term “memory” may refer to various types of processor-readable media, such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage devices, registers, and the like. A memory is said to be in electronic communication with a processor if the processor may read information from and/or write information to the memory. A memory integrated in a processor is in electronic communication with the processor.

Furthermore, terms such as first, second, A, B, (a), (b), and the like used in the following embodiments are used only to distinguish a certain component from other components, and the essence, order, or sequence of the corresponding component is not limited by such terms.

Furthermore, in the following embodiments, when a certain component is described as being “connected,” “coupled,” or “joined” to another component, the certain component may be directly connected or coupled to the other component, but it should be understood that another component may be “connected,” “coupled,” or “joined” between each component.

Furthermore, “comprises” and/or “comprising” used in the following embodiments does not exclude the presence or addition of one or more other components, steps, operations, and/or elements from the mentioned components, steps, operations, and/or elements.

Hereinafter, various embodiments of the present disclosure will be described in detail according to the accompanying drawings.

The present disclosure relates to an electronic device and a method for predicting an amount of solar power generation.

According to some embodiments of the present disclosure, by generating the predicted value of the amount of solar power generation based on the plurality of weather forecast data, accurate and stable prediction of the amount of solar power generation may be possible. Furthermore, accurate prediction of the amount of solar power generation may enable stable grid operation, and may minimize energy waste by optimizing the scheduling of an energy storage device. Additionally, because the supply amount of solar energy may be controlled, the utilization of solar energy may be improved, and performance monitoring of a solar power plant may also be possible through comparison between the predicted amount of power generation and the actual amount of power generation.

The effects of the present disclosure are not limited to the effects mentioned above, and other effects not mentioned may be clearly understood by those having ordinary skill in the art to which the present disclosure pertains (referred to as “those skilled in the art”) from the description of the claims.

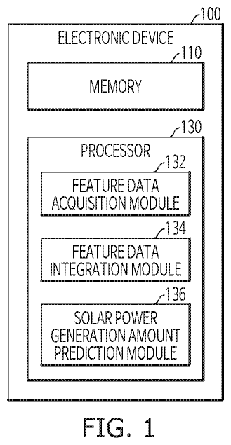

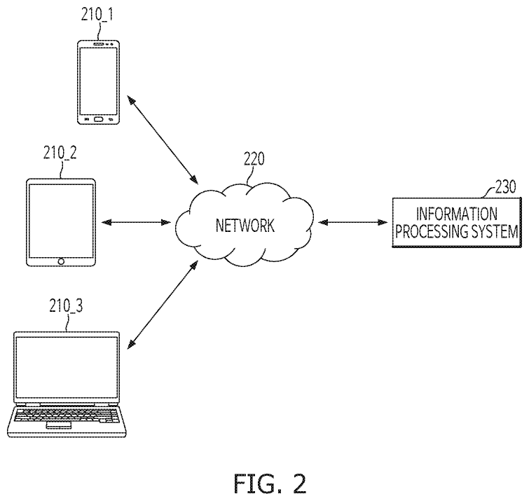

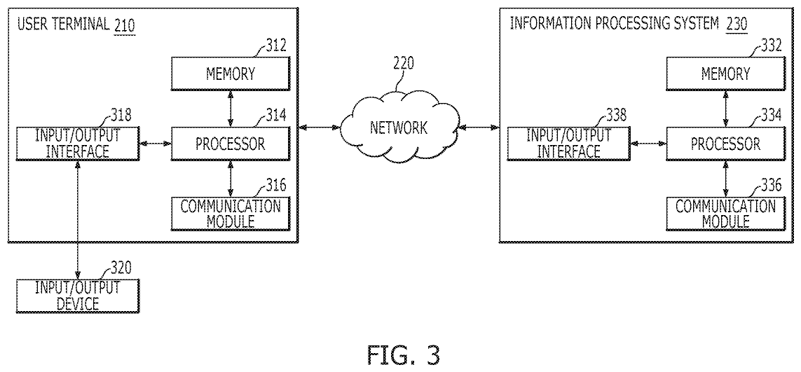

FIG. 1 illustrates a configuration of an electronic device 100 for predicting an amount of solar power generation according to an embodiment of the present disclosure. Referring to FIG. 1, the electronic device 100 for predicting an amount of solar power generation may include a memory 110 and a processor 130. However, the configuration of the electronic device 100 is not limited thereto. According to various embodiments, the electronic device 100 may further include at least one other component in addition to the components described above. According to an embodiment, the electronic device 100 may further include a communication circuit or a display. The communication circuit may support establishment of a direct (e.g., wired) communication channel or a wireless communication channel between the electronic device 100 and an external electronic device, and performance of communication through the established communication channel. For example, the electronic device 100 may receive weather forecast data from an external electronic device connected through the communication circuit. The display may visually provide information to the outside (e.g., a user) of the electronic device 100. For example, the electronic device 100 may display a predicted value of an amount of solar power generation through the display. In another example, when the electronic device 100 is a server (e.g., the information processing system of FIGS. 2 and 3), the electronic device 100 may transmit the predicted value of the amount of solar power generation to a user terminal.

The memory 110 may store various data used by at least one component (e.g., the processor 130) of the electronic device 100. The data may include, for example, software (or a program) and input data or output data for commands related thereto. The memory 110 may include a volatile memory or a non-volatile memory. According to an embodiment, the memory 110 may store weather forecast data.

The processor 130 may execute software (or a program) to control at least one other component (e.g., a hardware or software component) of the electronic device 100 connected to the processor 130, and may perform various data processing or operations. According to an embodiment, as at least part of the data processing or operations, the processor 130 may load a command or data received from another component into the volatile memory, process the command or data stored in the volatile memory, and store result data in the non-volatile memory.

According to an embodiment, the processor 130 may obtain a plurality of feature data based on a plurality of weather forecast data. Then, the processor 130 may obtain integrated feature data integrating the plurality of feature data based on a similarity among the plurality of feature data, and may generate a predicted value of the amount of solar power generation based on the integrated feature data. To this end, the processor 130 may include a feature data acquisition module 132, a feature data integration module 134, and a solar power generation amount prediction module 136. However, the types of modules included in the processor 130 are classified according to functions related to prediction of the amount of solar power generation, and the types and number thereof are not limited thereto. Furthermore, at least one of the modules included in the processor 130 may be implemented in the form of instructions stored in the memory 110.

In the present disclosure, the number of weather forecast data used for predicting the amount of solar power generation may be at least two or more (e.g., two, three, or the like), and the types thereof may also be various. For example, when the used weather forecast data has overlapping time ranges, the weather forecast data that may be used in the present disclosure may include at least two or more of ultra-short-term forecast data, short-term forecast data, medium-term forecast data, or long-term forecast data. However, in the embodiments described below, for convenience of description, a method of calculating the predicted value of the amount of solar power generation using two pieces of weather forecast data will be described. For example, the plurality of weather forecast data may include first weather forecast data comprising a weather predicted value of a first time interval within a designated time range and second weather forecast data comprising a weather predicted value of a second time interval longer than the first time interval within the designated time range.

According to an embodiment, the first weather forecast data may include forecast data obtained through a Local Data Assimilation and Prediction System (LDAPS), and the second weather forecast data may include forecast data obtained through a Global Data Assimilation and Prediction System (GDAPS). In an embodiment, the first weather forecast data and the second weather forecast data may be forecast data having different time ranges, time intervals, and/or regional ranges.

The feature data acquisition module 132 may obtain the plurality of feature data based on the plurality of weather forecast data. For example, feature data may be obtained/generated for each piece of weather forecast data. The process in which the feature data acquisition module 132 obtains the plurality of feature data may be referred to as a Temporal Fusion process. The temporal fusion process may include a process of matching the time lengths of the respective weather forecast data. First, when the time ranges (e.g., forecast periods) of the plurality of weather forecast data are different, the feature data acquisition module 132 may extract data corresponding to an overlapping time range from each of the plurality of weather forecast data. Furthermore, when the time intervals (e.g., forecast intervals) of the plurality of weather forecast data are different, the feature data acquisition module 132 may perform a function of matching the time length/interval in order to integrate (or mix) and use the plurality of weather forecast data. To this end, the feature data acquisition module 132 may obtain feature data including weather forecast information while preserving time-series information from each of the plurality of weather forecast data.

According to an embodiment, the feature data acquisition module 132 may obtain embedding vectors corresponding to each of the plurality of weather forecast data as the plurality of feature data. Here, the embedding vector may be a method of expressing data as a real-valued vector of a fixed dimension, or a result value obtained through the method. When the semantic similarity between data is high, the embedding vectors corresponding to the data may be located adjacent to each other in the space in which the embedding vectors are represented. The embedding vector corresponding to each of the plurality of weather forecast data may include time-series information of corresponding weather forecast data and may have a designated length (e.g., dimension). For example, when the plurality of weather forecast data includes the first weather forecast data having first time-series information and the second weather forecast data having second time-series information, a first embedding vector corresponding to the first weather forecast data and a second embedding vector corresponding to the second weather forecast data may include the first time-series information and the second time-series information, respectively, but a length (e.g., dimension) of the first embedding vector and a length (e.g., dimension) of the second embedding vector may be the same.

According to an embodiment, the feature data acquisition module 132 may generate the embedding vectors using an attention-based Long Short-Term Memory (LSTM). Here, the attention-based LSTM may be referred to as an Attentive LSTM. The LSTM may represent a model that shows high accuracy in the field of time-series prediction and serves as the basis of many time-series prediction models. For example, when a feature vector xₜ is received as input, the LSTM updates two state vectors ht−1 and ct−1 of the previous time point and outputs new state vectors hₜ and cₜ, wherein a hidden state vector h_{T} generated at the very last time point may become the final output value of the LSTM. However, the LSTM has a limitation that the values before the hidden state vector of the final time point cannot be used, so the Attentive LSTM that may compensate for this may be used. The Attentive LSTM does not use the hidden state vector of the last time point as the output value, and may calculate an attention value by utilizing the hidden state vector of each time point. Then, the Attentive LSTM may calculate a weighted sum of the hidden state vectors by using each attention value as a weight, and may output one context vector C. Through this process, weather forecast data of different lengths may all be expressed as embedding vectors of the same length while preserving time-series information. Through the following Mathematical Expression 1, an attention value ai for each time point of the Attentive LSTM and a context vector C may be calculated.

$${a}_{i} = \frac{exp ( exp ( {h}_{j} {h}_{T} ) )}{{\sum }_{j = 1}^{T} exp ( {h}_{j} {h}_{T} )} \qquad [ Mathematical Expression 1 ]$$

$$C = {\sum }_{i = 0}^{T} {a}_{i} {h}_{i}$$

Here, hᵢ may represent the hidden state vector of time point i (final when i=T), and ai may represent the attention value of time point i.

The feature data integration module 134 may obtain integrated feature data integrating the plurality of feature data based on the similarity among the plurality of feature data. The process in which the feature data integration module 134 obtains the integrated feature data may be referred to as a Feature Fusion process. The feature fusion process may include a process of identifying key information (or important information) that is highly relevant in the plurality of feature data and integrating the plurality of feature data.

According to an embodiment, the feature data integration module 134 may obtain the integrated feature data integrating the plurality of feature data by using a cross attention mechanism. First, the feature data integration module 134 may generate a Query matrix, a Key matrix, and a Value matrix which are used for an attention model and correspond to each of the plurality of feature data, based on the embedding vectors corresponding to each of the plurality of weather forecast data. For example, the feature data integration module 134 may generate a query matrix, a key matrix, and a value matrix associated with the first feature data (e.g., the first embedding vector) corresponding to the first weather forecast data, and may generate a query matrix, a key matrix, and a value matrix associated with the second feature data (e.g., the second embedding vector) corresponding to the second weather forecast data. According to an embodiment, the feature data integration module 134 may adjust the dimensions of the query matrix, the key matrix, and the value matrix through linear projection of the query matrix, the key matrix, and the value matrix.

Then, the feature data integration module 134 may calculate a first attention score indicating a similarity between a query and a key based on the key matrix associated with the first feature data and the query matrix associated with the second feature data, and may calculate a second attention score indicating a similarity between a query and a key based on the key matrix associated with the second feature data and the query matrix of the first feature data. According to an embodiment, the feature data integration module 134 may calculate an attention score (e.g., the first attention score or the second attention score) by using a matrix multiplication operation (or a dot product between matrices).

Then, the feature data integration module 134 may calculate a first attention value based on the first attention score and the value matrix associated with the first feature data, and may calculate a second attention value based on the second attention score and the value matrix associated with the second feature data. In this process, the feature data integration module 134 may calculate an attention weight by passing the attention score through a softmax function. For example, the feature data integration module 134 may calculate a first attention weight by applying the softmax function to the first attention score, and may calculate a second attention weight by applying the softmax function to the second attention score. Here, applying the softmax function is to obtain a probability distribution in which the sum of all values is 1, which is referred to as an attention distribution, and each value obtained by applying the softmax function, that is, the attention weight, may represent the importance of each key corresponding to the query. According to an embodiment, the feature data integration module 134 may perform scaling processing on the attention score before applying the softmax function. Here, performing the scaling operation may be for increasing numerical stability and computational efficiency. For example, due to the characteristics of the dot product calculation between matrices, as input values become longer, larger numbers may be obtained. Furthermore, the softmax function has a structure of applying an exponential function to each element of the input vector and normalizing the result to obtain a probability distribution, and because an exponential function is used, as the input value becomes larger, the result value increases rapidly, which may cause an overflow. Because such a phenomenon causes a gradient vanishing problem of the softmax function, the feature data integration module 134 may reduce the size of the attention score through the scaling operation before applying the softmax function, thereby increasing numerical stability and computational efficiency. Furthermore, the feature data integration module 134 may obtain the attention value by calculating a weighted sum of the value matrix through a matrix multiplication operation (or a dot product) between the attention weight and the value matrix. For example, the feature data integration module 134 may calculate the first attention value through the weighted sum of the first attention weight and the value matrix associated with the first feature data, and may calculate the second attention value through the weighted sum of the second attention weight and the value matrix associated with the second feature data. According to an embodiment, the feature data integration module 134 may adjust the dimension of the attention value through linear projection of the calculated attention value (e.g., the first attention value or the second attention value).

Then, the feature data integration module 134 may generate the integrated feature data by concatenating the calculated attention values. For example, the feature data integration module 134 may generate the integrated feature data by concatenating the first attention value and the second attention value.

According to an embodiment, the feature data integration module 134 may apply the integrated feature data to a Transformer model. For example, the feature data integration module 134 may extract key information (or important information) once more from the integrated feature data, that is, the concatenated attention values, through additional transformer operations. Here, the Transformer model has a structure of an encoder that compresses an input sequence into one vector representation and a decoder that generates an output sequence through the vector representation, but may be a model that does not use a Recurrent Neural Network (RNN) and is implemented using an attention mechanism. Because the transformer does not receive input values sequentially according to the position of the input sequence, positional encoding may be performed to add position information of the input value to the feature data (e.g., the embedding vector). Furthermore, the attention mechanism used in the transformer may include a self-attention mechanism. The self-attention mechanism may have a structure similar to the above-described cross attention mechanism, but may differ in that the input query matrix, key matrix, and value matrix come from the same source. For example, when the feature data integration module 134 applies the integrated feature data to the Transformer model, the transformer operation may include a self-attention operation, and the query matrix, the key matrix, and the value matrix used for the self-attention operation may be generated from the integrated feature data.

The solar power generation amount prediction module 136 may generate the predicted value of the amount of solar power generation based on the integrated feature data. The process in which the solar power generation amount prediction module 136 generates the predicted value of the amount of solar power generation may be referred to as a Multi-Layer Perceptron process. The multi-layer perceptron process may include a process of generating at least one predicted value of the amount of solar power generation having a designated time interval (e.g., a prediction interval) within a designated time range (e.g., a prediction period or a prediction date) that is a prediction target through a Multi-Layer Perceptron model using the integrated feature data. For example, the solar power generation amount prediction module 136 may generate predicted values of the amount of solar power generation corresponding to a 1-hour interval for 24 hours on day t, which is the prediction target day (e.g., a total of 24 predicted values). Here, the Multi-Layer Perceptron model is an artificial neural network model in which two or more hidden layers exist between an input layer and an output layer, and may be a model capable of identifying linear and non-linear relationships of data. According to an embodiment, the solar power generation amount prediction module 136 may use a leaky Rectified Linear Unit (ReLU) function as an activation function of the multi-layer perceptron.

Furthermore, the processor 130 may be configured to output a control signal to physically control an external energy storage system (ESS) or a facility of the solar power plant based on the generated predicted value of the amount of solar power generation. For example, the processor 130 may optimize scheduling of the energy storage system to charge or discharge power, or may control an operation mode of the solar power plant facility to stably manage power supply to a power grid. By executing such physical control operations based on the predicted value, the electronic device 100 may ensure stable grid operation and minimize energy waste.

In addition to the automated physical control, the processor 130 may be configured to transmit the predicted value and associated operation data to a user terminal (e.g., administrator terminal) over a communication network. For example, the processor 130 may transmit graphical user interface (GUI) data configured to visualize the predicted value alongside the actual amount of power generation on a real-time monitoring dashboard of the user terminal. As another example, when the predicted value falls below a predetermined threshold or a sudden drop in power generation is anticipated due to drastic weather variations, the processor 130 may transmit a warning alert or a push notification to the user terminal. Such data transmission not only facilitates remote monitoring and performance tracking of the solar power plant, but also supports manual override interventions or strategic decision-making by an administrator for maintenance and grid management.

As described above, the electronic device 100 for predicting an amount of solar power generation according to an embodiment of the present disclosure may obtain the plurality of feature data based on the plurality of weather forecast data, obtain the integrated feature data integrating the plurality of feature data based on the similarity among the plurality of feature data, and generate the predicted value of the amount of solar power generation based on the integrated feature data. For example, the electronic device 100 may extract key information (or important information) by using various pieces of information, that is, multiple weather forecast data, as input values, and may identify the relationship therebetween to integrate the weather forecast data into an embedding value (or embedding vector). Furthermore, the electronic device 100 may utilize the weather forecast data for both training and testing of the model in order to reduce dependence on model forecasts. For example, the electronic device 100 may train the model by using the weather forecast data throughout the entire process in order to identify a pattern between the weather forecast data and the amount of solar power generation.

In the present disclosure, the weather forecast data as source data (data used as an input value of a prediction model) used for predicting the amount of solar power generation may include various information/data related to weather. According to various embodiments, the weather forecast data may include not only forecast data obtained through a forecast model, but also prediction/observation data or information of various formats related to weather. For example, the weather forecast data may include satellite images, Social Network Service (SNS) data generated in an electronic device located in a region adjacent to a solar power plant, web portal search data, or the like.

FIG. 2 is a schematic diagram illustrating a configuration in which an information processing system 230 is communicably connected to a plurality of user terminals 210_1, 210_2, 210_3, in relation to data processing according to an embodiment of the present disclosure. The information processing system 230 may include system(s) capable of providing a data processing service (e.g., a solar power generation amount prediction-based service). In an embodiment, the information processing system 230 may include one or more server devices and/or databases, or one or more distributed computing devices and/or distributed databases based on a cloud computing service, capable of storing, providing, and executing a computer-executable program (e.g., a downloadable application) and data related to the data processing service. For example, the information processing system 230 may include separate systems (e.g., servers) for the data processing service.

The data processing service, and the like, provided by the information processing system 230 may be provided to a user through a data processing application, a web browser application, or the like, installed in each of the plurality of user terminals 210_1, 210_2, 210_3.

The plurality of user terminals 210_1, 210_2, 210_3 may communicate with the information processing system 230 through a network 220. The network 220 may be configured to enable communication between the plurality of user terminals 210_1, 210_2, 210_3 and the information processing system 230. The network 220 may be configured as, for example, a wired network such as Ethernet, a wired home network (Power Line Communication), a telephone line communication device, and RS-serial communication, a wireless network such as a mobile communication network, a Wireless LAN (WLAN), Wi-Fi, Bluetooth, and ZigBee, or a combination thereof, depending on the installation environment. The communication method is not limited, and may include a communication method utilizing a communication network (e.g., a mobile communication network, a wired Internet, a wireless Internet, a broadcasting network, a satellite network, etc.) that the network 220 may include, as well as short-range wireless communication between the user terminals 210_1, 210_2, 210_3.

For example, the plurality of user terminals 210_1, 210_2, 210_3 may transmit a data processing request and instructions associated with a user request for data processing to the information processing system 230 through the network 220, and the information processing system 230 may receive the data processing request and the instructions.

Although a mobile phone terminal 210_1, a tablet terminal 210_2, and a PC terminal 210_3 are illustrated as examples of the user terminal in FIG. 2, the user terminal is not limited thereto, and the user terminals 210_1, 210_2, 210_3 may be any computing device capable of wired and/or wireless communication and on which a data processing application, or the like, may be installed and executed. For example, the user terminal may include a smartphone, a mobile phone, a navigation device, a computer, a laptop, a digital broadcasting terminal, a Personal Digital Assistant (PDA), a Portable Multimedia Player (PMP), a tablet PC, a game console, a wearable device, an Internet of Things (IoT) device, a Virtual Reality (VR) device, an Augmented Reality (AR) device, and the like. Furthermore, although three user terminals 210_1, 210_2, 210_3 are illustrated as communicating with the information processing system 230 through the network 220 in FIG. 2, the present disclosure is not limited thereto, and a different number of user terminals may be configured to communicate with the information processing system 230 through the network 220.

When the information processing system 230 provides the solar power generation amount prediction-based service, the information processing system 230 may receive weather forecast data from the user terminals 210_1, 210_2, 210_3. In such a case, the information processing system 230 may generate the predicted value of the amount of solar power generation based on the plurality of weather forecast data. Then, the information processing system 230 may transmit the generated predicted value of the amount of solar power generation to the user terminals 210_1, 210_2, 210_3.

FIG. 3 is a block diagram illustrating an internal configuration of a user terminal 210 and the information processing system 230 according to an embodiment of the present disclosure. The user terminal 210 may refer to any computing device on which a data processing application, or the like, may be executed and that is capable of wired/wireless communication, and may include, for example, the mobile phone terminal 210_1, the tablet terminal 210_2, the PC terminal 210_3 of FIG. 2, and the like. As illustrated, the user terminal 210 may include a memory 312, a processor 314, a communication module 316, and an input/output interface 318. Similarly, the information processing system 230 may include a memory 332, a processor 334, a communication module 336, and an input/output interface 338. As illustrated in FIG. 3, the user terminal 210 and the information processing system 230 may be configured to communicate information and/or data through the network 220 by using the respective communication modules 316, 336. Furthermore, an input/output device 320 may be configured to input information and/or data to the user terminal 210 or output information and/or data generated from the user terminal 210 through the input/output interface 318.

The memories 312, 332 may include any non-transitory computer-readable recording medium. According to an embodiment, the memories 312, 332 may include a permanent mass storage device such as a Read Only Memory (ROM), a disk drive, a Solid State Drive (SSD), a flash memory, and the like. As another example, a permanent mass storage device such as a ROM, an SSD, a flash memory, a disk drive, or the like, may be included in the user terminal 210 or the information processing system 230 as a separate permanent storage device distinct from the memory. Furthermore, an operating system and at least one program code (for example, a code for an application, or the like, associated with the data processing service) may be stored in the memories 312, 332.

Such software components may be loaded from a computer-readable recording medium separate from the memories 312, 332. Such a separate computer-readable recording medium may include a recording medium directly connectable to the user terminal 210 and the information processing system 230, and may include, for example, a computer-readable recording medium such as a floppy drive, a disk, a tape, a DVD/CD-ROM drive, a memory card, or the like. As another example, the software components may be loaded into the memories 312, 332 through the communication modules 316, 336 rather than a computer-readable recording medium. For example, at least one program may be loaded into the memories 312, 332 based on a computer program (for example, an application associated with the data processing service, etc.) installed by files provided through the network 220 by developers or a file distribution system that distributes installation files of the application.

The processors 314, 334 may be configured to process instructions of a computer program by performing basic arithmetic, logic, and input/output operations. The instructions may be provided to the processors 314, 334 by the memories 312, 332 or the communication modules 316, 336. For example, the processors 314, 334 may be configured to execute received instructions according to a program code stored in a recording device such as the memories 312, 332.

The communication modules 316, 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system, etc.). For example, a request or data (e.g., a data processing request or data, etc.) generated by the processor 314 of the user terminal 210 according to a program code stored in a recording device such as the memory 312 may be transmitted to the information processing system 230 through the network 220 under the control of the communication module 316. Conversely, a control signal or command provided under the control of the processor 334 of the information processing system 230 may be received by the user terminal 210 through the communication module 316 of the user terminal 210 via the communication module 336 and the network 220.

The input/output interface 318 may be a means for interfacing with the input/output device 320. As an example, an input device may include a device such as a camera including an audio sensor and/or an image sensor, a keyboard, a microphone, a mouse, and the like, and an output device may include a device such as a display, a speaker, a haptic feedback device, and the like. As another example, the input/output interface 318 may be a means for interfacing with a device in which a configuration or function for performing input and output is integrated into one, such as a touch screen. Although the input/output device 320 is illustrated as not being included in the user terminal 210 in FIG. 3, the present disclosure is not limited thereto, and the input/output device 320 may be configured as one device with the user terminal 210. Furthermore, the input/output interface 338 of the information processing system 230 may be a means for interfacing with a device (not illustrated) for input or output that is connected to the information processing system 230 or may be included in the information processing system 230. Although the input/output interfaces 318, 338 are illustrated as elements configured separately from the processors 314, 334 in FIG. 3, the present disclosure is not limited thereto, and the input/output interfaces 318, 338 may be configured to be included in the processors 314, 334.

The user terminal 210 and the information processing system 230 may include more components than those of FIG. 3. However, there is no need to clearly illustrate most of the conventional technical components. In an embodiment, the user terminal 210 may be implemented to include at least some of the input/output devices 320 described above. Furthermore, the user terminal 210 may further include other components such as a transceiver, a Global Positioning System (GPS) module, a camera, various sensors, a database, and the like. For example, when the user terminal 210 is a smartphone, the user terminal 210 may include components generally included in a smartphone, and may be implemented to further include various components such as, for example, an acceleration sensor, a gyro sensor, a microphone module, a camera module, various physical buttons, buttons using a touch panel, input/output ports, a vibrator for vibration, and the like.

According to an embodiment, the processor 314 of the user terminal 210 may be configured to operate a data processing application or a web browser application that provides the data processing service. At this time, a program code associated with the corresponding application may be loaded into the memory 312 of the user terminal 210. While the application is operating, the processor 314 of the user terminal 210 may receive information and/or data provided from the input/output device 320 through the input/output interface 318, or may receive information and/or data from the information processing system 230 through the communication module 316, and may process the received information and/or data and store the received information and/or data in the memory 312. Furthermore, such information and/or data may be provided to the information processing system 230 through the communication module 316.

While the data processing application is operating, the processor 314 may receive voice data, text, images, videos, and the like, input or selected through an input device such as a touch screen, a keyboard, a camera including an audio sensor and/or an image sensor, a microphone, and the like, connected to the input/output interface 318, and may store the received voice data, text, images, and/or videos, and the like, in the memory 312 or may provide the received voice data, text, images, and/or videos, and the like, to the information processing system 230 through the communication module 316 and the network 220. In an embodiment, the processor 314 may receive a user input that is input through the input device, and may provide data/a request corresponding to the received user input to the information processing system 230 through the network 220 and the communication module 316.

The processor 314 of the user terminal 210 may transmit information and/or data to the input/output device 320 through the input/output interface 318 and output the information and/or data. For example, the processor 314 of the user terminal 210 may output the processed information and/or data through the output device 320 such as a display output capable device (e.g., a touch screen, a display, etc.), a voice output capable device (e.g., a speaker), and the like.

The processor 334 of the information processing system 230 may be configured to manage, process, and/or store information and/or data received from the plurality of user terminals 210 and/or a plurality of external systems. The information and/or data processed by the processor 334 may be provided to the user terminal 210 through the communication module 336 and the network 220.

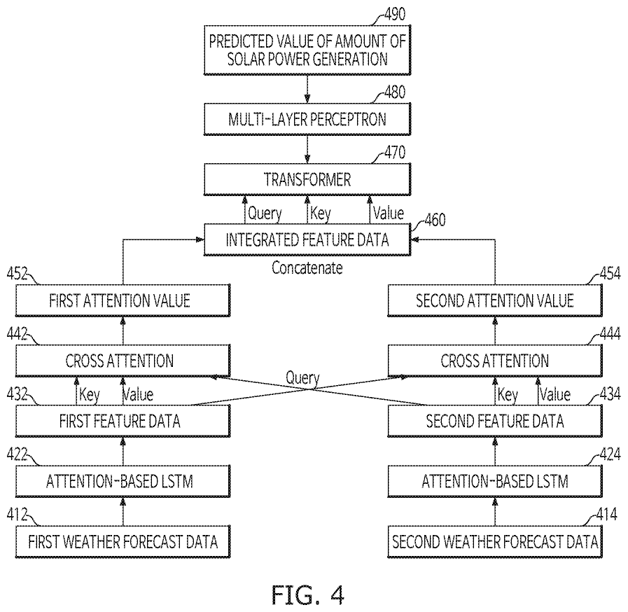

FIG. 4 illustrates a method of calculating a predicted value of an amount of solar power generation according to an embodiment of the present disclosure. Referring to FIG. 4, an electronic device (e.g., the electronic device 100 of FIG. 1) for predicting an amount of solar power generation may generate a predicted value 490 of the amount of solar power generation by using a plurality of weather forecast data (e.g., first weather forecast data 412 and second weather forecast data 414). Hereinafter, for convenience of description, a case in which the plurality of weather forecast data is two pieces of weather forecast data will be described, but the number of weather forecast data is not limited thereto. For example, the used weather forecast data may be three or more.

Looking at the process of generating the predicted value 490 of the amount of solar power generation, first, the electronic device (or at least one processor of the electronic device) may obtain first feature data 432 and second feature data 434 based on the first weather forecast data 412 and the second weather forecast data 414, respectively. In this process, when the time ranges (e.g., forecast periods) of the first weather forecast data 412 and the second weather forecast data 414 are different, the electronic device may extract data corresponding to an overlapping time range from the first weather forecast data 412 and the second weather forecast data 414. Furthermore, the electronic device may obtain the first feature data 432 from the first weather forecast data 412 (or the extracted first weather forecast data) by using an attention-based LSTM 422, and may obtain the second feature data 434 from the second weather forecast data 414 (or the extracted second weather forecast data) by using an attention-based LSTM 424. According to an embodiment, the first feature data 432 may include a first embedding vector, and the second feature data 434 may include a second embedding vector. For example, the electronic device may generate embedding vectors (e.g., the first embedding vector and the second embedding vector) having the same length (e.g., dimension) while preserving time-series information of each of the weather forecast data 412, 414, from each of the weather forecast data 412, 414 by using the attention-based LSTMs 422, 424.

Then, the electronic device may obtain integrated feature data 460 integrating the first feature data 432 and the second feature data 434 based on a similarity between the first feature data 432 and the second feature data 434. In this process, the electronic device may generate a query matrix, a key matrix, and a value matrix corresponding to each of the first feature data 432 and the second feature data 434. For example, the electronic device may generate a query matrix, a key matrix, and a value matrix associated with the first feature data 432 (e.g., the first embedding vector), and may generate a query matrix, a key matrix, and a value matrix associated with the second feature data 434 (e.g., the second embedding vector).

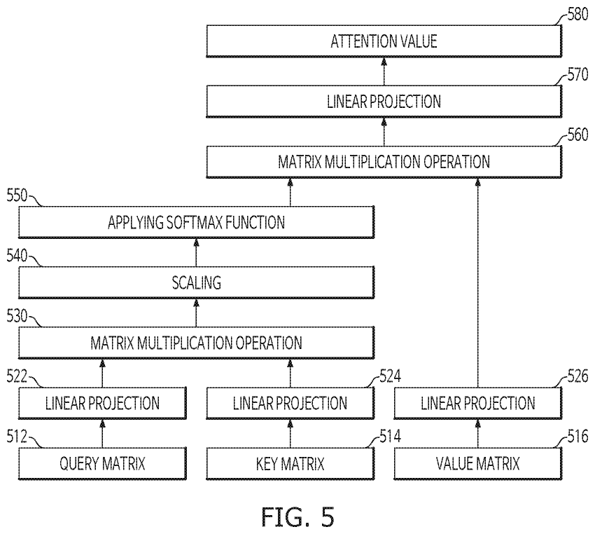

Then, the electronic device may obtain a first attention value 452 and a second attention value 454 based on the first feature data 432 and the second feature data 434 through cross attention 442, 444 mechanisms. For example, the electronic device may use a query associated with the second feature data 434 for the cross attention 442 for calculating the first attention value 452, and may use a query associated with the first feature data 432 for the cross attention 444 for calculating the second attention value 454. Furthermore, the electronic device may generate the integrated feature data 460 by concatenating the first attention value 452 and the second attention value 454. The cross attention 442, 444 mechanisms will be described in detail with reference to FIG. 5.

Then, the electronic device may apply the integrated feature data 460 to a transformer 470 model. For example, the electronic device may extract key information (or important information) once more from the integrated feature data 460 through additional operations of the transformer 470. Here, the attention mechanism used in the transformer 470 may include a self-attention mechanism. The self-attention mechanism may have a structure similar to the cross attention 442, 444 mechanisms, but may differ in that the input query matrix, key matrix, and value matrix come from the same source (e.g., the integrated feature data 460).

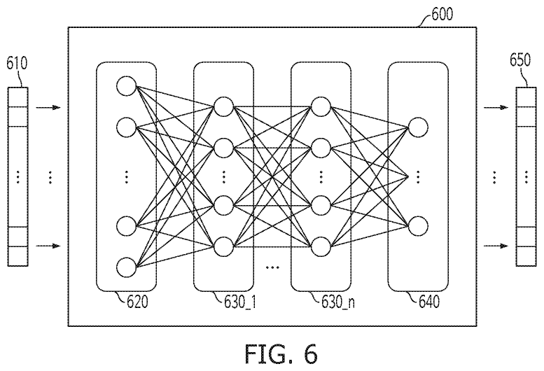

Then, the electronic device may generate the predicted value 490 of the amount of solar power generation based on the integrated feature data 460. For example, the electronic device may generate the predicted value 490 of the amount of solar power generation based on the integrated feature data 460 additionally applied to the transformer 470 model. According to an embodiment, the electronic device may input the integrated feature data 460 as an input value to a multi-layer perceptron 480 model and obtain the predicted value 490 of the amount of solar power generation as an output value. Here, the electronic device may use a leaky ReLU function as an activation function of the multi-layer perceptron. The multi-layer perceptron 480 model will be described in detail with reference to FIG. 6.

FIG. 5 illustrates a method of calculating an attention value according to an embodiment of the present disclosure. Referring to FIG. 5, the electronic device (e.g., the electronic device 100 of FIG. 1) for predicting an amount of solar power generation may calculate an attention value 580 through an attention mechanism. Here, the attention mechanism may dynamically adjust a weight for an output corresponding to each element of an input to support a model focusing on important information. The attention mechanism may include a self-attention mechanism, a cross attention mechanism, and the like.

Looking at the process of calculating the attention value 580 through the attention mechanism, first, the electronic device may obtain a query matrix 512, a key matrix 514, and a value matrix 516 based on feature data (e.g., an embedding vector). For example, the electronic device may generate a query matrix, a key matrix, and a value matrix associated with first feature data (e.g., a first embedding vector) corresponding to first weather forecast data, and may generate a query matrix, a key matrix, and a value matrix associated with second feature data (e.g., a second embedding vector) corresponding to second weather forecast data.

Then, the electronic device may perform linear projection operations 522, 524, 526 on the query matrix 512, the key matrix 514, and the value matrix 516. For example, the electronic device may adjust the dimensions of the query matrix 512, the key matrix 514, and the value matrix 516 through the linear projection operations 522, 524, 526.

Then, the electronic device may calculate an attention score indicating a similarity between the query matrix 512 and the key matrix 514 based on the query matrix 512 and the key matrix 514. For example, the electronic device may calculate the attention score through a matrix multiplication operation 530 (or a dot product) on the query matrix 512 and the key matrix 514. The query matrix 512 used in this process may be different between the self-attention mechanism and the cross attention mechanism. For example, in the self-attention mechanism, the query matrix 512 and the key matrix 514 are obtained from the same source (e.g., the same embedding vector), but in the cross attention mechanism, the query matrix 512 and the key matrix 514 may be obtained from different sources (e.g., different embedding vectors).

Then, the electronic device may perform scaling 540 processing on the attention score. For example, the electronic device may reduce the size of the attention score through the scaling 540 operation, thereby increasing numerical stability and computational efficiency.

Then, the electronic device may apply 550 a softmax function to the scaled attention score. For example, the electronic device may input the attention score into the softmax function to calculate an attention weight. Here, the attention weight may represent the importance of each key matrix 514 corresponding to the query matrix 512.

Then, the electronic device may calculate the attention value 580 through a matrix multiplication operation 560 (or a dot product) between the attention weight and the value matrix 516. For example, the electronic device may calculate the attention value 580 through a weighted sum of the attention weight and the value matrix 516. Then, the electronic device may adjust the dimension of the attention value 580 through linear projection 570 of the calculated attention value 580.

FIG. 6 illustrates an artificial neural network model 600 according to an embodiment of the present disclosure. Referring to FIG. 6, the artificial neural network model 600 may represent, as an example of a machine learning model, a statistical learning algorithm implemented based on a biological neural network structure in machine learning technology and cognitive science, or a structure that executes the algorithm.

According to an embodiment, the artificial neural network model 600 may represent a machine learning model having problem-solving capability, in which nodes, which are artificial neurons forming a network through the coupling of synapses like a biological neural network, learn by repeatedly adjusting the weights of synapses so that an error between a correct output and an inferred output corresponding to a specific input is reduced.

According to an embodiment, the above-described prediction model of the amount of solar power generation may be generated in the form of the artificial neural network model 600. For example, the artificial neural network model 600 may receive weather forecast data of a region associated with a solar power plant, and may estimate an expected amount of power generation based on the weather forecast data.

The artificial neural network model 600 may be implemented as a multi-layer perceptron composed of multi-layered nodes and connections therebetween. The artificial neural network model 600 according to the present embodiment may be implemented using one of various artificial neural network model structures including a multi-layer perceptron. The artificial neural network model 600 may be composed of an input layer 620 that receives input data 610 (or an input signal) from the outside, an output layer 640 that outputs output data 650 (or an output signal) corresponding to the input data 610, and n (where n is a positive integer) hidden layers 630_1 to 630_n that are located between the input layer 620 and the output layer 640, receive signals from the input layer 620, extract features, and transfer the features to the output layer 640. Here, the output layer 640 may receive signals from the hidden layers 630_1 to 630_n and output the signals to the outside.

The training method of the artificial neural network model 600 may include a supervised learning method that learns to be optimized for problem solving by inputting a teacher signal (or label) that is a correct answer, and an unsupervised learning method that does not require a teacher signal. According to an embodiment, the electronic device (e.g., the electronic device 100 of FIG. 1) according to an embodiment of the present disclosure may train the artificial neural network model 600 using a plurality of weather forecast data.

According to an embodiment, the electronic device may generate training data for training the artificial neural network model 600. For example, the electronic device may generate a training data set including the plurality of weather forecast data. Then, the electronic device may train the artificial neural network model 600 for calculating the predicted value of the amount of solar power generation based on the generated training data set.

According to an embodiment, input variables of the artificial neural network model 600 may include the plurality of weather forecast data. When the above-described input variables are input through the input layer 620, an output variable output from the output layer 640 of the artificial neural network model 600 may be the predicted value of the amount of solar power generation.

In this way, the plurality of input variables and the corresponding plurality of output variables may be respectively matched to the input layer 620 and the output layer 640 of the artificial neural network model 600, and synapse values between the nodes included in the input layer 620, the hidden layers 630_1 to 630_n, and the output layer 640 may be adjusted, so that the artificial neural network model 600 may be trained to extract the correct output corresponding to a specific input. Through such a training process, features hidden in the input variables of the artificial neural network model 600 may be identified, and the synapse values (or weights) between the nodes of the artificial neural network model 600 may be adjusted so that the error between the output variable calculated based on the input variables and the target output is reduced. Furthermore, the electronic device may train an algorithm that receives the plurality of weather forecast data as input, and may conduct training in a manner that minimizes the loss with respect to the predicted value of the amount of solar power generation (i.e., the annotation information).

Using the artificial neural network model 600 trained in such a manner, the predicted value of the amount of solar power generation may be estimated.

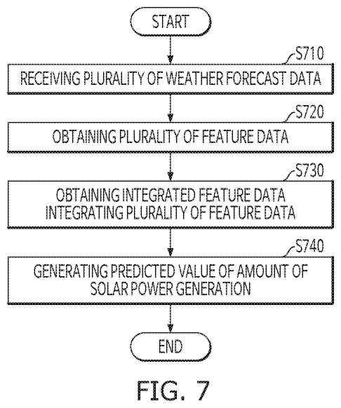

FIG. 7 illustrates a method of predicting an amount of solar power generation according to an embodiment of the present disclosure. Referring to FIG. 7, in step 710 (S710), the processor (e.g., the processor 130 of FIG. 1) of the electronic device (e.g., the electronic device 100 of FIG. 1) for predicting an amount of solar power generation may receive a plurality of weather forecast data. As an example, the processor may receive the plurality of weather forecast data from at least one external electronic device connected through a communication circuit. As another example, the processor may receive the plurality of weather forecast data from a memory (e.g., the memory 110 of FIG. 1). In the present disclosure, the number of weather forecast data used for predicting the amount of solar power generation may be at least two or more (e.g., two, three, or the like), and the types thereof may also be various. For example, the plurality of weather forecast data may include first weather forecast data comprising a weather predicted value of a first time interval within a designated time range and second weather forecast data comprising a weather predicted value of a second time interval longer than the first time interval within the designated time range. According to an embodiment, the first weather forecast data may include forecast data obtained through a Local Data Assimilation and Prediction System (LDAPS), and the second weather forecast data may include forecast data obtained through a Global Data Assimilation and Prediction System (GDAPS).

In step 720 (S720), the processor may obtain a plurality of feature data. For example, the processor may obtain the plurality of feature data based on the plurality of weather forecast data. According to an embodiment, the processor may obtain embedding vectors corresponding to each of the plurality of weather forecast data as the plurality of feature data. The embedding vector corresponding to each of the plurality of weather forecast data may include time-series information of corresponding weather forecast data, and may have a designated length (e.g., dimension). According to an embodiment, the processor may generate the embedding vectors using an attention-based LSTM.

In step 730 (S730), the processor may obtain integrated feature data integrating the plurality of feature data. For example, the processor may obtain the integrated feature data integrating the plurality of feature data based on a similarity among the plurality of feature data. According to an embodiment, the processor may obtain the integrated feature data integrating the plurality of feature data by using a cross attention mechanism. For example, the processor may first generate a query matrix, a key matrix, and a value matrix associated with first feature data based on the first feature data (e.g., a first embedding vector) corresponding to first weather forecast data among the plurality of weather forecast data, and may generate a query matrix, a key matrix, and a value matrix associated with second feature data based on the second feature data (e.g., a second embedding vector) corresponding to second weather forecast data among the plurality of weather forecast data. Then, the processor may calculate a first attention score based on the key matrix associated with the first feature data and the query matrix associated with the second feature data, and may calculate a second attention score based on the key matrix associated with the second feature data and the query matrix of the first feature data. Then, the processor may calculate a first attention value based on the first attention score and the value matrix associated with the first feature data, and may calculate a second attention value based on the second attention score and the value matrix associated with the second feature data. Then, the processor may generate the integrated feature data by concatenating the first attention value and the second attention value.

According to an embodiment, the processor may apply the integrated feature data to a Transformer model. For example, the processor may extract key information (or important information) once more from the integrated feature data, that is, the concatenated attention values, through additional transformer operations.

In step 740 (S740), the processor may generate a predicted value of the amount of solar power generation. For example, the processor may generate the predicted value of the amount of solar power generation based on the integrated feature data. According to an embodiment, the processor may generate the predicted value of the amount of solar power generation through a multi-layer perceptron model using the integrated feature data. According to an embodiment, the processor may use a leaky ReLU function as an activation function of the multi-layer perceptron.

The flowchart and the description described above are merely examples, and in some embodiments, may be implemented differently. For example, in some embodiments, the order of each step may be changed, some steps may be repeatedly performed, some steps may be omitted, or some steps may be added.

The above-described method may be provided as a computer program stored in a computer-readable recording medium for execution on a computer. The medium may continuously store a computer-executable program, or may temporarily store a computer-executable program for execution or download. Furthermore, the medium may be various recording means or storage means in the form of a single or several combined hardware, and is not limited to a medium directly connected to a certain computer system, and may exist in a distributed manner on a network. Examples of the medium may include magnetic media such as a hard disk, a floppy disk, and a magnetic tape, optical recording media such as a CD-ROM and a DVD, magneto-optical media such as a floptical disk, and those configured to store program instructions, including ROM, RAM, flash memory, and the like. Furthermore, as examples of other media, recording media or storage media managed by an app store that distributes applications or sites, servers, or the like, that supply or distribute various other software may also be mentioned.

The method, operation, or techniques of the present disclosure may be implemented by various means. For example, such techniques may be implemented in hardware, firmware, software, or a combination thereof. Those skilled in the art will understand that various illustrative logical blocks, modules, circuits, and algorithm steps described in connection with the disclosure herein may be implemented in electronic hardware, computer software, or a combination of both. To clearly illustrate such interchangeability of hardware and software, various illustrative components, blocks, modules, circuits, and steps have been generally described above from a functional perspective. Whether such functionality is implemented as hardware or software depends on the particular application and design constraints imposed on the overall system. Those skilled in the art may implement the described functionality in varying ways for each particular application, but such implementations should not be interpreted as causing a departure from the scope of the present disclosure.

In a hardware implementation, the processing units used to perform the techniques may be implemented in one or more ASICs, DSPs, Digital Signal Processing Devices (DSPDs), Programmable Logic Devices (PLDs), Field Programmable Gate Arrays (FPGAs), processors, controllers, microcontrollers, microprocessors, electronic devices, other electronic units designed to perform the functions described in the present disclosure, a computer, or a combination thereof.

Accordingly, the various illustrative logic blocks, modules, and circuits described in connection with the present disclosure may be implemented or performed by a general-purpose processor, a DSP, an ASIC, an FPGA or other programmable logic device, discrete gate or transistor logic, discrete hardware components, or any combination of those designed to perform the functions described herein. The general-purpose processor may be a microprocessor, but alternatively, the processor may be any conventional processor, controller, microcontroller, or state machine. The processor may also be implemented as a combination of computing devices, for example, a combination of a DSP and a microprocessor, a plurality of microprocessors, one or more microprocessors in conjunction with a DSP core, or any other such configuration.

In a firmware and/or software implementation, the techniques may be implemented as instructions stored on a computer-readable medium such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage device, or the like. The instructions may be executable by one or more processors, and may cause the processor(s) to perform certain aspects of the functionality described in the present disclosure.

When implemented in software, the techniques described above may be stored on a computer-readable medium as one or more instructions or code, or transmitted through a computer-readable medium. Computer-readable media include both computer storage media and communication media, including any medium that facilitates transfer of a computer program from one place to another. Storage media may be any available media that may be accessed by a computer. By way of non-limiting example, such computer-readable media may include RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Furthermore, any connection is properly termed a computer-readable medium.

For example, when software is transmitted from a website, a server, or other remote source using coaxial cable, fiber optic cable, twisted pair, digital subscriber line (DSL), or wireless technologies such as infrared, radio, and microwave, the coaxial cable, fiber optic cable, twisted pair, digital subscriber line, or wireless technologies such as infrared, radio, and microwave are included in the definition of medium. As used herein, a disk and a disc include a CD, a laser disc, an optical disc, a digital versatile disc (DVD), a floppy disk, and a Blu-ray disc, where disks usually reproduce data magnetically, while discs reproduce data optically using lasers. Combinations of the above should also be included within the scope of computer-readable media.

The software module may reside in a RAM memory, a flash memory, a ROM memory, an EPROM memory, an EEPROM memory, registers, a hard disk, a removable disk, a CD-ROM, or any other form of storage medium known in the art. An exemplary storage medium may be coupled to a processor such that the processor may read information from, or write information to, the storage medium. Alternatively, the storage medium may be integrated into the processor. The processor and storage medium may reside in an ASIC. The ASIC may reside in a user terminal. Alternatively, the processor and the storage medium may reside as discrete components in a user terminal.

Although the embodiments described above have been described as utilizing aspects of the presently disclosed subject matter in one or more stand-alone computer systems, the present disclosure is not limited thereto, and may be implemented in conjunction with any computing environment, such as a network or distributed computing environment. Furthermore, aspects of the subject matter in the present disclosure may be implemented in a plurality of processing chips or devices, and storage may be similarly affected across a plurality of devices. Such devices may include PCs, network servers, and portable devices.

Although the present disclosure has been described in connection with some embodiments in the present specification, various modifications and changes may be made without departing from the scope of the present disclosure, which may be understood by those of ordinary skill in the art to which the invention of the present disclosure pertains. Furthermore, such modifications and changes should be considered to fall within the scope of the claims appended to the present specification.

What is claimed is:

1. An electronic device comprising:
a memory; and
a processor operatively connected to the memory,
wherein the processor is configured to cause the electronic device to:
receive a plurality of weather forecast data;
obtain, based on the plurality of weather forecast data, a plurality of feature data;
obtain, based on a similarity among the plurality of feature data, integrated feature data integrating the plurality of feature data;
generate, based on the integrated feature data, a predicted value of an amount of solar power generation; and
control, based on the generated predicted value, a system comprising at least one solar power generator associated with the solar power generation.

2. The electronic device as claimed in claim 1, wherein the processor is configured to cause the electronic device to control at least one apparatus to control at least one of power storage or power transfer of power generated by the at least one solar power generator associated with the solar power generation, and
wherein the plurality of weather forecast data comprise:
first weather forecast data comprising a weather predicted value of a first time interval within a designated time range, and
second weather forecast data comprising a weather predicted value of a second time interval longer than the first time interval within the designated time range.

3. The electronic device as claimed in claim 1, wherein the processor is configured to cause the electronic device to obtain a plurality of embedding vectors corresponding to the plurality of weather forecast data, respectively, as the plurality of feature data, and
wherein each embedding vector comprises time-series information of corresponding weather forecast data among the plurality of weather forecast data, and each embedding vector has a designated length.

4. The electronic device as claimed in claim 3, wherein the processor is configured to cause the electronic device to generate the plurality of embedding vectors using an attention-based Long Short-Term Memory (LSTM).

5. The electronic device as claimed in claim 3, wherein the processor is configured to cause the electronic device to generate, for each of the plurality of feature data, a Query matrix, a Key matrix, and a Value matrix, wherein the Query matrix, the Key matrix, and the Value matrix are used for an attention model, based on the plurality of embedding vectors corresponding to the plurality of weather forecast data, respectively.

6. The electronic device as claimed in claim 5, wherein the processor is configured to cause the electronic device to:
calculate, based on a key matrix associated with first feature data among the plurality of feature data and a query matrix associated with second feature data among the plurality of feature data, a first attention score indicating a similarity between a corresponding query and a corresponding key;
calculate, based on the first attention score and a value matrix associated with the first feature data, a first attention value;
calculate, based on a key matrix associated with the second feature data and a query matrix of the first feature data, a second attention score indicating a similarity between a corresponding query and a corresponding key;
calculate, based on the second attention score and a value matrix associated with the second feature data, a second attention value; and
generate the integrated feature data by concatenating the first attention value and the second attention value.

7. The electronic device as claimed in claim 6, wherein the processor is configured to cause the electronic device to apply the integrated feature data to a Transformer model.

8. The electronic device as claimed in claim 1, wherein the processor is configured to cause the electronic device to generate the predicted value of the amount of solar power generation through a Multi-Layer Perceptron model using the integrated feature data.

9. The electronic device as claimed in claim 8, wherein an activation function of the Multi-Layer Perceptron comprises a leaky Rectified Linear Unit (ReLU) function.

10. A method performed by at least one processor of an apparatus, the method comprising:
receiving a plurality of weather forecast data;
obtaining, based on the plurality of weather forecast data, a plurality of feature data;
obtaining, based on a similarity among the plurality of feature data, integrated feature data integrating the plurality of feature data;
generating, based on the integrated feature data, a predicted value of an amount of solar power generation; and
controlling, based on the generated predicted value, a system comprising at least one solar power generator associated with the solar power generation.

11. The method as claimed in claim 10, wherein the plurality of weather forecast data comprise:
first weather forecast data comprising a weather predicted value of a first time interval within a designated time range, and
second weather forecast data comprising a weather predicted value of a second time interval longer than the first time interval within the designated time range.

12. The method as claimed in claim 10, wherein the obtaining of the plurality of feature data comprises obtaining a plurality of embedding vectors corresponding to the plurality of weather forecast data, respectively, as the plurality of feature data, and
wherein each embedding vector comprises time-series information of corresponding weather forecast data among the plurality of weather forecast data, and each embedding vector has a designated length.

13. The method as claimed in claim 12, further comprising:
generating the plurality of embedding vectors using an attention-based Long Short-Term Memory (LSTM).

14. The method as claimed in claim 12, further comprising:
generating, for each of the plurality of feature data, a Query matrix, a Key matrix, and a Value matrix, wherein the Query matrix, the Key matrix, and the Value matrix are used for an attention model, based on the plurality of embedding vectors corresponding to the plurality of weather forecast data, respectively.

15. The method as claimed in claim 14, wherein the obtaining of the integrated feature data comprises:
calculating, based on a key matrix associated with first feature data among the plurality of feature data and a query matrix associated with second feature data among the plurality of feature data, a first attention score indicating a similarity between a corresponding query and a corresponding key;
calculating, based on the first attention score and a value matrix associated with the first feature data, a first attention value;
calculating, based on a key matrix associated with the second feature data and a query matrix of the first feature data, a second attention score indicating a similarity between a corresponding query and a corresponding key;
calculating, based on the second attention score and a value matrix associated with the second feature data, a second attention value; and
generating the integrated feature data by concatenating the first attention value and the second attention value.

16. The method as claimed in claim 15, further comprising:
applying the integrated feature data to a Transformer model.

17. The method as claimed in claim 10, wherein the generating of the predicted value of the amount of solar power generation comprises generating the predicted value of the amount of solar power generation through a Multi-Layer Perceptron model using the integrated feature data.

18. The method as claimed in claim 17, wherein an activation function of the Multi-Layer Perceptron comprises a leaky Rectified Linear Unit (ReLU) function.

19. The method as claimed in claim 10, wherein the controlling of the system comprises controlling at least one of power storage or power transfer of power generated by the at least one solar power generator associated with the solar power generation.
